(19) United States
(12) Patent Application Publication
(10) Pub. No.: US 2026/0166883 A1
(43) Pub. Date: Jun. 18, 2026

(54) LIQUID DISCHARGE APPARATUS

(71) Applicant: Takeyuki KOBAYASHI, Kanagawa (JP)

(72) Inventor: Takeyuki KOBAYASHI, Kanagawa (JP)

(21) Appl. No.: 19/370,830

(22) Filed: Oct. 28, 2025

(30) Foreign Application Priority Data
Dec. 18, 2024 (JP) 2024-221454

(51) Int. Cl. B41J 2/165

(52) U.S. Cl. CPC B41J 2/16552; B41J 2/16535

(57) ABSTRACT

A liquid discharge apparatus includes a liquid discharge head, a roller, and a cleaner. The liquid discharge head has a nozzle face having a nozzle to discharge a liquid, in a discharge direction, to a medium conveyed in a conveyance direction orthogonal to the discharge direction; and moves in a scanning direction orthogonal to the discharge direction and the conveyance direction. The roller moves in the scanning direction; and rotates and contacts a surface of the medium. The cleaner cleans each of the nozzle face and the roller.

### CROSS-REFERENCE TO RELATED APPLICATION

This patent application is based on and claims priority pursuant to 35 U.S.C. § 119(a) to Japanese Patent Application No. 2024-221454, filed on Dec. 18, 2024, in the Japan Patent Office, the entire disclosure of which is hereby incorporated by reference herein.

### BACKGROUND

### Technical Field

The present disclosure relates to a liquid discharge apparatus.

### Related Art

In the related art, a liquid discharge apparatus, such as an inkjet image forming apparatus, includes a liquid discharge head that discharges liquid onto a sheet and a cleaning device that cleans the liquid discharge head.

### SUMMARY

The present disclosure described herein provides an improved liquid discharge apparatus including a liquid discharge head, a roller, and a cleaner. The liquid discharge head has a nozzle face having a nozzle to discharge a liquid, in a discharge direction, to a medium conveyed in a conveyance direction orthogonal to the discharge direction; and moves in a scanning direction orthogonal to the discharge direction and the conveyance direction. The roller moves in the scanning direction; and rotates and contacts a surface of the medium. The cleaner cleans each of the nozzle face and the roller.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a plan view of an image forming apparatus;

FIG. 2 is a front view of an image forming apparatus, illustrating an operation in a smoothing step;

FIG. 3 is a front view of an image forming apparatus, illustrating an operation in a pretreatment liquid applying step;

FIG. 4 is a front view of an image forming apparatus including a height detection sensor;

FIG. 5 is a front view of the image forming apparatus of FIG. 4, illustrating a height detection method by the height detection sensor;

FIG. 6 is another front view of the image forming apparatus of FIG. 4, illustrating a height detection method by the height detection sensor;

FIG. 7 is a front view of an image forming apparatus including another height detection sensor;

FIG. 8 is a front view of an image forming apparatus, illustrating a smoothing step in which a smoothing roller avoids a projection on a sheet;

FIG. 9 is a schematic diagram illustrating a basic configuration of a maintenance unit;

FIG. 10 is a block diagram illustrating a configuration of a controller of an image forming apparatus;

FIG. 11 is a diagram illustrating a configuration of a pretreatment maintenance unit and a cleaning operation;

FIG. 12 is another diagram illustrating a configuration of a pretreatment maintenance unit and a cleaning operation;

FIG. 13 is a flowchart of the cleaning operation by the pretreatment maintenance unit of FIGS. 11 and 12;

FIG. 14 is a diagram illustrating a configuration of a pretreatment maintenance unit and a cleaning operation;

FIG. 15 is a flowchart of the cleaning operation by the pretreatment maintenance unit of FIG. 14;

FIG. 16 is a diagram illustrating a relationship between positions at which a cleaning liquid is applied to a smoothing roller and at which a wiper contacts the smoothing roller;

FIG. 17 is a flowchart of a cleaning operation by a pretreatment maintenance unit;

FIG. 18 is a diagram illustrating a configuration of the pretreatment maintenance unit and the cleaning operation of FIG. 17; and

FIG. 19 is a flowchart of control of a cleaning timing for cleaning a smoothing roller.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

With reference to the drawings, descriptions are given below of embodiments of the present disclosure. In the drawings for illustrating embodiments of the present disclosure, like reference signs are assigned to elements such as components and parts that have a like function or a like shape as far as distinguishable, and descriptions of such elements may be omitted once the description is provided.

A configuration of a liquid discharge apparatus will be described below. As an example, the liquid discharge apparatus is an inkjet image forming apparatus.

### Overall Configuration of Image Forming Apparatus

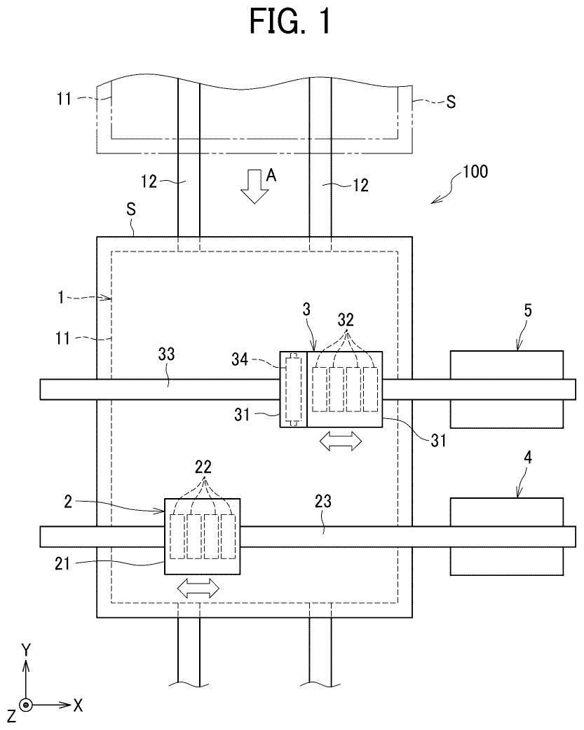

FIG. 1 is a plan view of an image forming apparatus 100. In FIG. 1, X, Y, and Z directions are defined as directions along three-dimensional coordinate axes of the image forming apparatus 100, for convenience. Specifically, the X direction corresponds to a transverse direction as the image forming apparatus 100 is viewed from above, and the Y direction corresponds to a longitudinal direction orthogonal to the X direction (transverse direction) as the image forming apparatus 100 is viewed from above. The Z direction corresponds to a direction (e.g., a vertical upward direction when the image forming apparatus 100 is placed on a horizontal plane) orthogonal to both the X and Y directions as the image forming apparatus 100 is viewed from above. The X, Y, and Z directions in the other drawings are also identical to the X, Y, and Z directions in FIG. 1.

As illustrated in FIG. 1, the image forming apparatus 100 includes a sheet conveyance unit 1, an image forming unit 2, a pretreatment unit 3, an image formation maintenance unit 4, and a pretreatment maintenance unit 5.

The sheet conveyance unit 1 as a conveyor includes a placement section 11 on which a sheet S is to be placed as a recording medium (may be referred to simply as a medium) and guide rails 12 along which the placement section 11 is to be guided in the Y direction and the direction opposite to the Y direction (i.e., Y directions) to convey the sheet S in the Y directions (i.e., a conveyance direction). An upper surface of the placement section 11 is a plane defined by the X and Y directions and is also a placement surface on which the sheet S is to be placed.

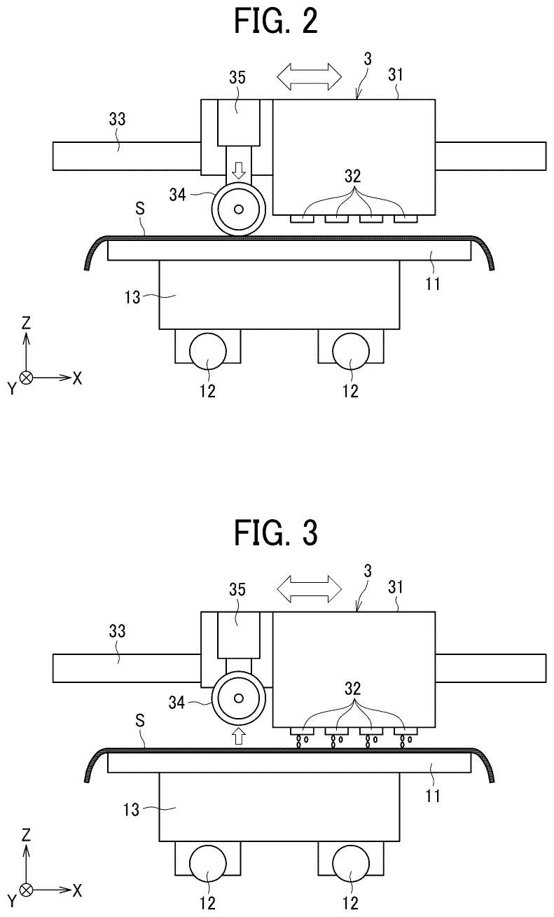

As illustrated in FIG. 2, when the image forming apparatus 100 is viewed in the Y direction, the placement section 11 is supported on a support table 13, which functions as a driver. With the movement of the support table 13 upward or downward, the placement section 11 is reciprocally movable in the Z direction and the direction opposite to the Z direction (i.e., Z directions).

The sheet S may be plain paper, glossy paper, special paper, or other types of paper. Alternatively, building materials such as wallpaper, flooring materials, and tiles, fabrics for clothing such as T-shirts, textiles, and leather may be employed as the sheet S. Moreover, the sheet S may be made of ceramic, glass, a metal, or other material. Alternatively, the sheet S may be made of a non-permeable substrate. The non-permeable substrate refers to a substrate having a surface with a low level of moisture permeability and absorptivity. Examples thereof include a material having a number of hollow spaces inside but not open to the exterior. To be more quantitative, the non-permeable substrate refers to a substrate that absorbs water in an amount of 10 mL/m² or less in a period from the start of contact to 30 msec^{1/2}, when measured according to the Bristow method. Specific examples of the non-permeable substrate include plastic films, such as a vinyl chloride resin film, a polyethylene terephthalate (PET) film, and polypropylene, polyethylene, and polycarbonate films.

The image forming unit 2 includes a carriage 21 and ink discharge heads 22. The carriage 21 is reciprocally movable along a guide rail 23 extending in the X direction (i.e., a scanning direction). The ink discharge heads 22 each serve as a liquid discharge head that discharges ink as a liquid onto the sheet S in the Z directions (i.e., a discharge direction). The ink discharge heads 22 are mounted on the carriage 21. The ink discharge heads 22 reciprocate in the X direction and the direction opposite to the X direction (i.e., X directions) along the guide rail 23 together with the carriage 21. In this case, for example, the multiple ink discharge heads 22 discharge inks (liquids) of different colors, such as yellow, magenta, cyan, and black, respectively. The number of the ink discharge heads 22 and the colors of the inks to be discharged can be appropriately changed.

The pretreatment unit 3 includes a carriage 31, pretreatment liquid discharge heads 32, and a smoothing roller 34. The smoothing roller 34 may be referred to simply as a roller. The carriage 31 is reciprocally movable along a guide rail 33 extending in the X direction (i.e., the scanning direction). The pretreatment liquid discharge heads 32 each serve as a liquid discharge head that discharges a pretreatment liquid onto a surface of the sheet S in the discharge direction. The smoothing roller 34 serves as a smoother that smooths the surface of the sheet S. The pretreatment liquid discharge heads 32 and the smoothing roller 34 are mounted on the carriage 31. The pretreatment liquid discharge heads 32 and the smoothing roller 34 reciprocate (move) in the X directions (i.e., the scanning direction) along the guide rail 33 together with the carriage 31. An elevating driver 35 is driven as a driver illustrated in FIG. 2 to move the smoothing roller 34 in the Z directions, which are directions orthogonal to or intersecting a surface (image forming surface) of the sheet S. The smoother is not limited to the smoothing roller 34 and may be, for example, a smoothing blade. The number of the pretreatment liquid discharge heads 32 is not limited to two or more, and may be one.

The image formation maintenance unit 4 maintains or recovers a state of the ink discharge head 22. If the ink discharge head 22 has not been used for a long time, the ink remaining in a nozzle of the ink discharge head 22 may be dried and thickened. The nozzle may be clogged with the thickened residual ink to lower the ink discharging performance from the nozzle.

Furthermore, foreign matter, such as dust, adhering to a nozzle face may also lower the ink discharging performance. Accordingly, when the ink discharge head 22 has not been used, the image formation maintenance unit 4 is used to prevent the nozzle of the ink discharge head 22 from being dried or to remove the foreign matter adhering to the nozzle face of the ink discharge head 22. As a result, the ink discharging performance of the ink discharge head 22 can be maintained or recovered.

The pretreatment maintenance unit 5 maintains or recovers a state of the pretreatment liquid discharge head 32. Dried residual liquid in the nozzle of the pretreatment liquid discharge head 32 or foreign matter adhering to the nozzle face may also lower the pretreatment liquid discharging performance of the pretreatment liquid discharge head 32. Thus, the pretreatment maintenance unit 5 is used to maintain or recover the pretreatment liquid discharging performance. The detailed configurations of the pretreatment maintenance unit 5 and the image formation maintenance unit 4 will be described later.

### Image Forming Operation

A description will be given below of an image forming operation to be performed by the image forming apparatus 100. As illustrated in FIG. 1, when the placement section 11 on which sheet S is placed moves in the direction (i.e., a sheet conveyance direction A) indicated by arrow A from a position indicated by the two-dot chain line, the sheet S is conveyed toward the pretreatment unit 3. The sheet conveyance direction A may be referred to simply as the conveyance direction.

After the sheet S has been conveyed to the pretreatment unit 3, when the leading end of the sheet S reaches a range of movement of the pretreatment unit 3, the conveyance of the sheet S is temporarily stopped. Then, the sheet S is subjected to a smoothing step by the smoothing roller 34 and a pretreatment liquid applying step by the pretreatment liquid discharge head 32.

Specifically, first, as illustrated in FIG. 2, the smoothing roller 34 moves downward and comes into contact with a surface (upper face) of the sheet S. Then, while the smoothing roller 34 contacts the sheet S, the carriage 31 reciprocates along the guide rail 33. As a result, the smoothing roller 34 reciprocates while rotating in contact with the surface (upper face) of the sheet S. During this reciprocation, the smoothing roller 34 presses the surface of the sheet S to prevent fluffing or unevenness of the surface of the sheet S and smooth (flatten) the surface of the sheet S.

Following the above, as illustrated in FIG. 3, the smoothing roller 34 moves upward to a retraction position at which the smoothing roller 34 is retracted from the surface of the sheet S. Then, with the smoothing roller 34 kept at the retraction position, the carriage 31 reciprocates along the guide rail 33 while the pretreatment liquid discharge heads 32 discharge the pretreatment liquid onto the sheet S. As a result, the pretreatment liquid is applied onto the surface of the sheet S which has been smoothed by the smoothing roller 34.

After pretreatment steps, including the smoothing step and the pretreatment liquid applying step as described above, the placement section 11 moves again to convey the sheet S toward the image forming unit 2. When the leading end of the sheet S reaches a range of movement of the image forming unit 2, the conveyance of the sheet S is temporarily stopped again. The image forming unit 2 then performs an image forming step. Specifically, the carriage 21 mounting the ink discharge heads 22 reciprocates along the guide rail 23 while the ink discharge heads 22 discharge the inks onto the sheet S. As a result, the inks are applied onto the surface of the sheet S to form an image. Images to be formed on the sheet S may not only be meaningful images, such as characters or figures, but also be images having no meaning, such as patterns.

When the leading end of the sheet S reaches the range of movement of the image forming unit 2 along with the conveyance of the sheet S as described above, another portion of the sheet S which has not yet been subjected to the pretreatment steps reaches the range of movement of the pretreatment unit 3, which is disposed upstream of the image forming unit 2 in the sheet conveyance direction A. Accordingly, in parallel with the image forming step by the image forming unit 2, the pretreatment unit 3 subjects the portion of the sheet S which has newly reached the range of movement of the pretreatment unit 3 to the above pretreatment steps (smoothing step and pretreatment liquid applying step).

Following the above, when the sheet S is intermittently conveyed, the sheet S is repeatedly subjected to the pretreatment steps by the pretreatment unit 3 and the image forming step by the image forming unit 2 in the same manner. As a result, the entire image forming area of the sheet S is subjected to the smoothing step and the pretreatment liquid applying step, and an image is formed in the image forming area of the sheet S which has been subjected to the smoothing step and the pretreatment liquid applying step.

Following the above, the placement section 11 is moved to a predetermined home position, and the sheet S is taken from the placement section 11, so that the sheet S on which a desired image has been formed is provided.

As described above, the image forming apparatus 100 performs the smoothing step on a portion of the sheet S on which an image has not yet been formed to successfully form a high-quality image on the sheet S. In other words, since the pretreatment liquid and the ink are sequentially applied to the surface of the sheet S which has been flattened by the smoothing step, the pretreatment liquid and the inks can be uniformly applied to the surface of the sheet S. As a result, color unevenness, blur, and other color-related disadvantages can be prevented.

As described above, in parallel with the image forming step by the image forming unit 2, the pretreatment step(s) (the smoothing step or both the smoothing step and the pretreatment liquid applying step) is/are performed on a new portion of the sheet S which has reached the range of movement of the pretreatment unit 3. This configuration can make the processing time shorter than the processing time taken in a case where the image forming step and the pretreatment step(s) are performed at different timings.

The smoothing step is not necessarily performed before the pretreatment liquid applying step. Alternatively, the smoothing step may be performed after the pretreatment liquid applying step. In this case, the smoothing roller 34 is mounted on the carriage 31 together with the pretreatment liquid discharge heads 32 as described above. With this configuration, the smoothing step can be swiftly performed before the pretreatment liquid that has been applied to the sheet S is dried.

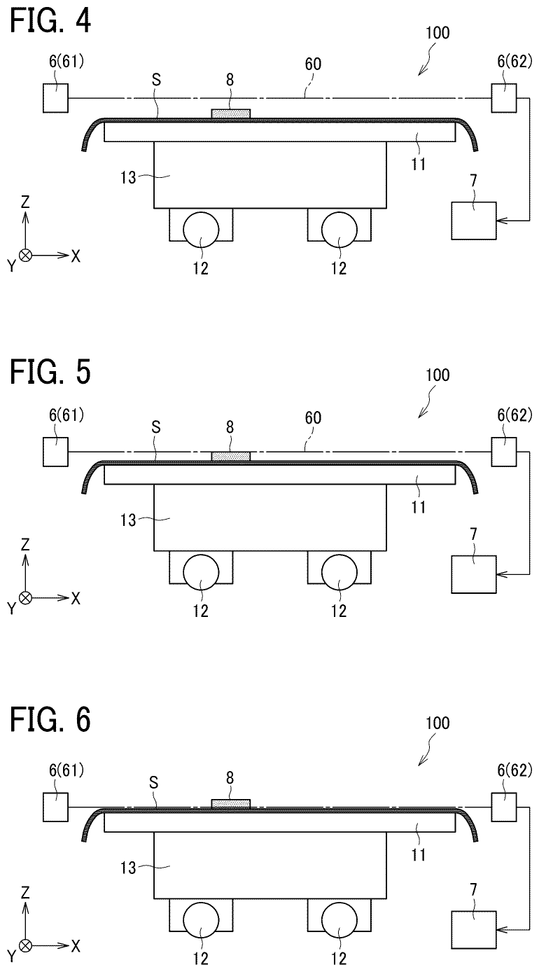

As illustrated in FIG. 4, the image forming apparatus 100 may further include a height detection sensor 6 that detects, for example, a height of the image forming surface (upper face) of the sheet S. For example, the height detection sensor 6 is a pair of optical sensors 61 and 62, which are disposed on both sides of the placement section 11 with the sheet S therebetween. The placement section 11 is vertically movable in the Z directions. Thus, the optical sensors 61 and 62 detect the height of an object when the object to be detected on the placement section 11 passes between the optical sensors 61 and 62 along with the vertical movement of the placement section 11. For example, when a projection 8 on the sheet S reaches a detection position 60 of the height detection sensor 6 as illustrated in FIG. 5 or when the image forming surface of the sheet S reaches the detection position 60 of the height detection sensor 6 as illustrated in FIG. 6, the height of the projection 8 or the height of the image forming surface is detected by the height detection sensors 6. Information regarding the height detected by the height detection sensor 6 is stored in a storage 7.

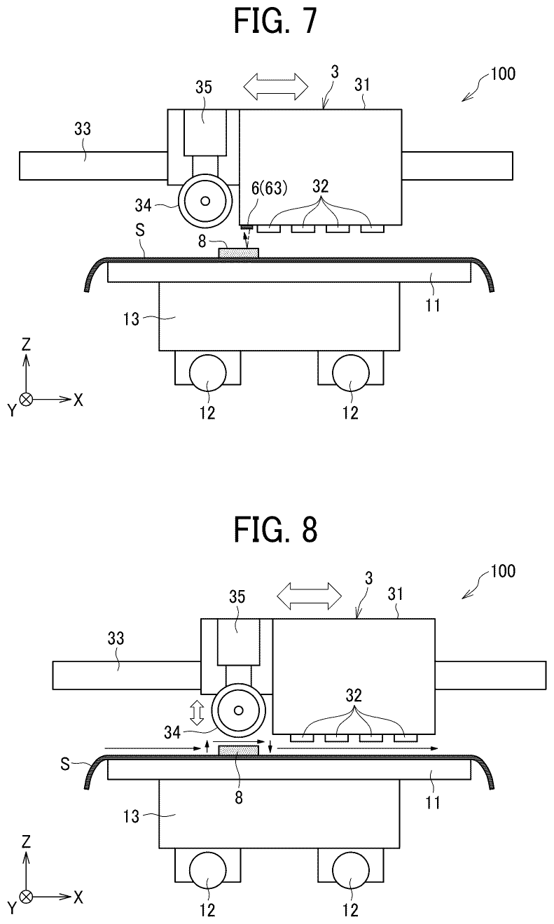

The height detection sensor 6 may employ a distance sensor 63 that detects a distance to an object (e.g., the projection 8 or the sheet S), as illustrated in FIG. 7. In this case, the height detection sensor 6 (distance sensor 63) is mounted on the carriage 31 to detect a height of (a distance to) the image forming surface of the sheet S or a height of the projection 8 during the movement of the carriage 31.

The image forming apparatus 100 that includes the height detection sensor 6, as described above, can detect whether the projection 8 is present on the sheet S based on the information regarding the detected height. Thus, the smoothing roller 34 can also move on the sheet S while avoiding the projection 8, as illustrated in FIG. 8. In this case, when the smoothing roller 34 reaches the position immediately in front of the projection 8, the smoothing roller 34 temporarily moves upward and avoids coming into contact with the projection 8. Then, when the smoothing roller 34 has traversed the projection 8, the smoothing roller 34 moves downward and comes into contact with the sheet S. In this way, the smoothing step can be performed on the entire surface of the sheet S other than the projection 8 to reduce fluffing or unevenness of the sheet S.

### Configuration of Maintenance Units

A description will be given below of configurations of the image formation maintenance unit 4 and the pretreatment maintenance unit 5. The basic configurations of the image formation maintenance unit 4 and the pretreatment maintenance unit 5 are the same as each other. Thus, both the image formation maintenance unit 4 and the pretreatment maintenance unit 5 will be collectively referred to as the “maintenance units 4 and 5” in the following description, and the basic configurations thereof will be described below. Both the ink discharge head 22 and the pretreatment liquid discharge head 32 to be maintained are also collectively referred to as the “discharge heads 22 and 32”.

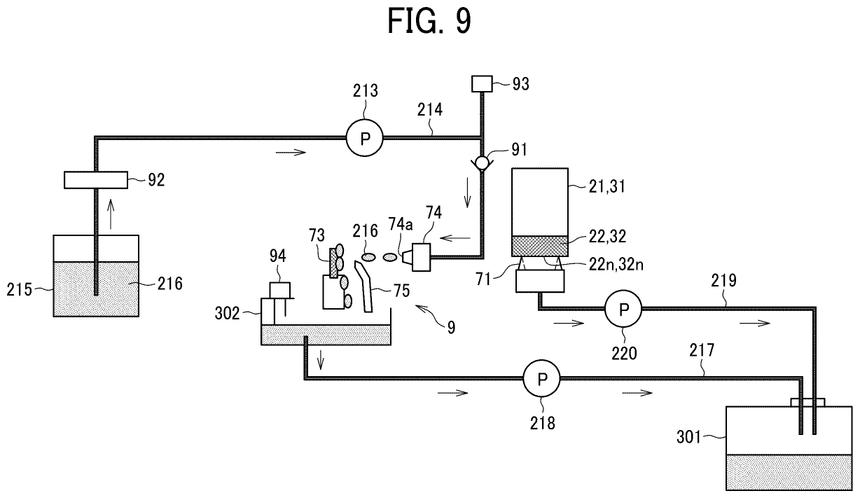

FIG. 9 is a schematic diagram illustrating the basic configuration of the maintenance units 4 and 5. As illustrated in FIG. 9, each of the maintenance units 4 and 5 includes: a cap 71 that covers a nozzle face 22n or 32n of the discharge heads 22 and 32; and a cleaning device 9 that cleans the nozzle face 22n or 32n of the discharge heads 22 and 32.

The cap 71 covers the nozzle face 22n or 32n of the discharge heads 22 and 32 and moisturizes and sucks the nozzle. When the discharge heads 22 and 32 are not used, the discharge heads 22 and 32 move to home positions facing the cap 71, and the cap 71 caps the discharge heads 22 and 32. In other words, after the discharge heads 22 and 32 have moved to the home positions, the cap 71 moves to the nozzle face 22n or 32n of the discharge heads 22 and 32 and then covers the nozzle face 22n or 32n. This operation prevents the liquid (ink) remaining on the nozzle face 22n or 32n and the liquid (ink) inside the nozzle from being dried to reduce clogging of the nozzle due to drying and adhesion of the residual liquid. Furthermore, the operation also prevents foreign matter from adhering to the nozzle face 22n or 32n to maintain the liquid (ink) discharging performance of the discharge heads 22 and 32.

The cap 71 is coupled, via a flexible tube 219, to a suction pump 220, which serves as a suction mechanism. By driving the suction pump 220 with the nozzle face 22n or 32n capped by the cap 71, the nozzle is sucked so that the liquid remaining in the nozzle is sucked and removed. This operation prevents the residual liquid in the nozzle from being fixed. The sucked liquid is drained into a waste liquid tank 301 via the flexible tube 219.

The cleaning device 9 as a cleaner includes a wiper 73 that wipes the nozzle face 22n or 32n of the discharge heads 22 and 32. The wiper 73 can move in directions orthogonal to or intersecting the direction of movement of the discharge heads 22 and 32. Before wiping the nozzle face 22n or 32n, the wiper 73 moves to a nozzle face wiping position (height) at which the wiper 73 can come into contact with the nozzle face 22n or 32n. Then, the carriage 21 or 31 moves to a position at which the discharge heads 22 and 32 face the wiper 73. When the discharge heads 22 and 32 reach the position facing the wiper 73, the wiper 73 comes into contact with the nozzle face 22n or 32n. Then, the discharge heads 22 and 32 further move so that the wiper 73 slides over the nozzle face 22n or 32n. With this operation, the wiper 73 wipes the nozzle face 22n or 32n to remove liquid remaining on and foreign matter adhering to the nozzle face 22n or 32n therefrom. The residual liquid and foreign matter removed by the wiper 73 are collected into a collection container 302 disposed below the wiper 73.

In addition to the wiper 73, the cleaning device 9 includes: a cleaning liquid applicator 74 that applies a cleaning liquid to the wiper 73; and a scraper 75 that removes liquid and foreign matter adhering to the wiper 73.

If residual liquid or foreign matter that has been removed in the wiping operation is left on the wiper 73, some of the liquid or the foreign matter may also adhere to the nozzle face 22n or 32n from the wiper 73 during the wiping operation that will be performed next. Accordingly, when foreign matter adheres to the wiper 73, the scraper 75 is pressed against the wiper 73. In this state, the wiper 73 moves to remove the foreign matter adhering to the wiper 73. By removing foreign matter on the wiper 73 in this manner, the residual liquid can be prevented from adhering to the nozzle face 22n or 32n from the wiper 73 to enhance the cleaning performance.

When the wiper 73 is dirty, the cleaning liquid applicator 74 may apply the cleaning liquid to the wiper 73. The cleaning liquid applicator 74 is coupled to a cleaning liquid supply pump 213 and a cleaning liquid storage tank 215 via a cleaning liquid supply tube 214. As the cleaning liquid supply pump 213 is driven, a cleaning liquid 216 is supplied from the cleaning liquid storage tank 215 to the cleaning liquid applicator 74. A filter 92 is disposed upstream of the cleaning liquid supply pump 213. A check valve 91 is disposed downstream of the cleaning liquid supply pump 213. The discharge pressure of the cleaning liquid supply pump 213 is regulated based on a pressure detected by a pressure sensor 93.

When the wiper 73 is cleaned, the wiper 73 moves to a position (i.e., a first position) facing a cleaning liquid nozzle 74a of the cleaning liquid applicator 74. Then, the cleaning liquid supply pump 213 is driven to supply the cleaning liquid 216 from the cleaning liquid storage tank 215 to the cleaning liquid applicator 74. As a result, the cleaning liquid 216 is sprayed toward the wiper 73 through the cleaning liquid nozzle 74a, so that the cleaning liquid 216 is applied to the wiper 73. By applying the cleaning liquid 216 to the wiper 73 in this manner, dirt on the wiper 73 is washed out, so that the wiping function of the wiper 73 can be recovered. In this case, the cleaning liquid that has been washed away from the wiper 73 is collected into the collection container 302. The collection container 302 is provided with a liquid level detection sensor 94 that detects the surface of the collected cleaning liquid. When the liquid level detection sensor 94 detects the surface of the cleaning liquid, a waste liquid pump 218 is driven to drain the cleaning liquid in the collection container 302 into the waste liquid tank 301 via a waste cleaning liquid tube 217.

The cleaning liquid 216 may include a very low-volatile solvent (also referred to as a wet liquid), such as glycerin or polyethylene glycol. The solvent may be a known organic solvent that can be selected depending on the intended purpose. In addition, the cleaning liquid 216 may be a liquid including a solvent alone or a liquid including water (e.g., purified water, highly pure water, or ultrapure water) alone. Alternatively, the cleaning liquid 216 may include any surfactant. If the cleaning liquid 216 includes a surfactant, the surface tension to the nozzle faces can be adjusted to enhance the cleaning effect.

### Configuration of Controller

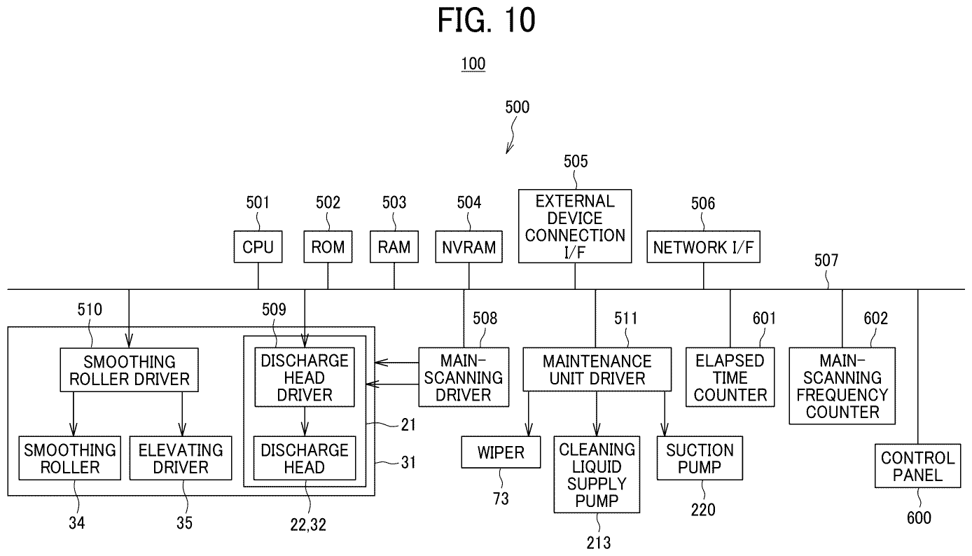

FIG. 10 is a block diagram illustrating a configuration of a controller 500 of the image forming apparatus 100. As illustrated in FIG. 10, the image forming apparatus 100 includes the controller 500 that controls the entire operation of the image forming apparatus 100.

The controller 500 as circuitry includes a central processing unit (CPU) 501, a read-only memory (ROM) 502, a random-access memory (RAM) 503, a nonvolatile random-access memory (NVRAM) 504, an external device connection interface (I/F) 505, a network I/F 506, and a bus line 507.

The CPU 501 controls the entire operation of the image forming apparatus 100. The ROM 502 stores programs, such as an initial program loader (IPL) used for driving the CPU 501. The RAM 503 is used as a work area for the CPU 501. The NVRAM 504 stores various kinds of data, such as programs, and retains the various kinds of data even while the image forming apparatus 100 is powered off.

The external device connection I/F 505 is connected to a personal computer (PC) via, for example, a universal serial bus (USB) cable to perform data communication with the PC to transmit/receive control signals and data regarding an image to be printed. The network I/F 506 is an interface for data communication using a communication network such as the Internet. The bus line 507 is, for example, an address bus or data bus for electrically connecting the components such as the CPU 501.

The controller 500 further includes a main-scanning driver 508, a discharge head driver 509, a smoothing roller driver 510, and a maintenance unit driver 511. The main-scanning driver 508 controls the movements of the carriages 21 and 31 in a main-scanning direction (the movement in the X directions). The discharge head driver 509 controls discharge operations of the discharge heads 22 and 32. The smoothing roller driver 510 controls a vertical movement (reciprocation in the Z directions) of the smoothing roller 34 and rotational driving of the smoothing roller 34. The maintenance unit driver 511 controls driving of the wiper 73 of each of the maintenance units 4 and 5, driving of the cleaning liquid supply pump 213, and driving of the suction pump 220.

The controller 500 acquires information entered through a control panel 600, time information measured by an elapsed time counter 601, and main-scanning frequency information counted by a main-scanning frequency counter 602.

The control panel 600 is an input unit, for example, including a touch panel, which is installed in the body of the image forming apparatus 100. When a user operates the control panel 600 to enter printing conditions, such as image information, the controller 500 generates an image-forming signal in accordance with those printing conditions. Then, the discharge head driver 509 controls the ink discharge heads 22 based on the generated image-forming signal. A desired image is thereby formed on the sheet.

The elapsed time counter 601 measures a time elapsed from a predetermined timing, or an origin point. The controller 500 controls timings of maintenance operations by the maintenance units 4 and 5, based on the elapsed time measured by the elapsed time counter 601.

The main-scanning frequency counter 602 counts the number of movements of the carriages 21 and 31 in the main-scanning direction. The controller 500 controls, for example, a timing of the maintenance operation by each of the maintenance units 4 and 5, based on the number of movements counted by the main-scanning frequency counter 602.

### Cleaning of Smoothing Roller

In a configuration including the smoothing roller 34 that smooths the surface of the sheet S, when the smoothing step is performed, foreign matter, such as fibers, dust, and pretreatment liquid, on the sheet S may adhere to the surface of the smoothing roller 34. When the next smoothing step is performed with foreign matter adhering to the surface of the smoothing roller 34, the foreign matter on the smoothing roller 34 may adhere to the sheet S, lowering the quality of the image formed on the sheet S.

To avoid such a situation, the smoothing roller 34 is cleaned so that the foreign matter is not on the surface of the smoothing roller 34. However, if a cleaning device dedicated to cleaning the smoothing roller 34 is additionally installed, the entire apparatus may become larger, or the cost of the apparatus may increase. To address such a situation, a configuration of a cleaning device is proposed as follows. A description will be given below of the configuration of the cleaning device.

### Configuration of Cleaning Device

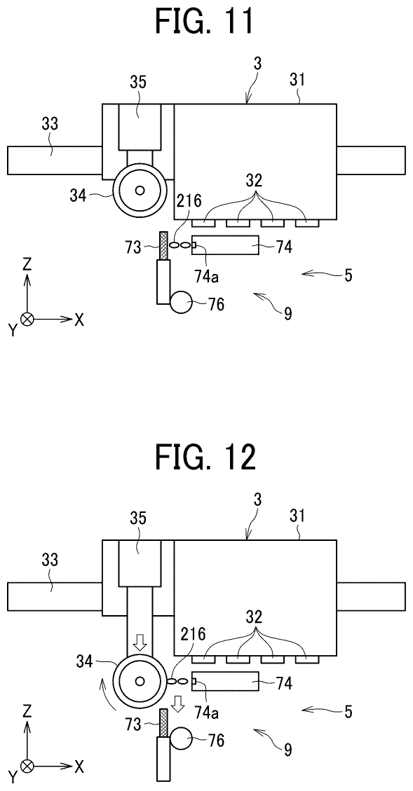

FIGS. 11 and 12 are diagrams each illustrating a configuration of the pretreatment maintenance unit 5 and a cleaning operation. As illustrated in FIGS. 11 and 12, the cleaning device 9 for the pretreatment maintenance unit 5 includes: the wiper 73 that wipes the nozzle faces 32n of the pretreatment liquid discharge heads 32; and the cleaning liquid applicator 74 that applies the cleaning liquid to the wiper 73.

The cleaning device 9 further includes a wiper driver 76 that reciprocally moves the wiper 73 in the Z directions. With this configuration, the wiper 73 is movable in the Z directions (i.e., the discharge direction) between a wiper cleaning position (i.e., the first position) (see FIG. 11) facing the cleaning liquid nozzle 74a of the cleaning liquid applicator 74 and a wiper retraction position (i.e., a second position) (see FIG. 12) at which the wiper 73 is retracted from the cleaning position.

The cleaning device 9 cleans each of the nozzle faces 32n of the pretreatment liquid discharge heads 32 and a circumferential surface of the smoothing roller 34. As illustrated in FIG. 12, the cleaning device 9 causes the cleaning liquid applicator 74 to apply the cleaning liquid 216 to the smoothing roller 34. For that purpose, along with the driving of the elevating driver 35, the smoothing roller 34 can move from a roller retraction position (see FIG. 11) to a roller cleaning position (see FIG. 12) facing the cleaning liquid nozzle 74a of the cleaning liquid applicator 74.

### Cleaning Operation

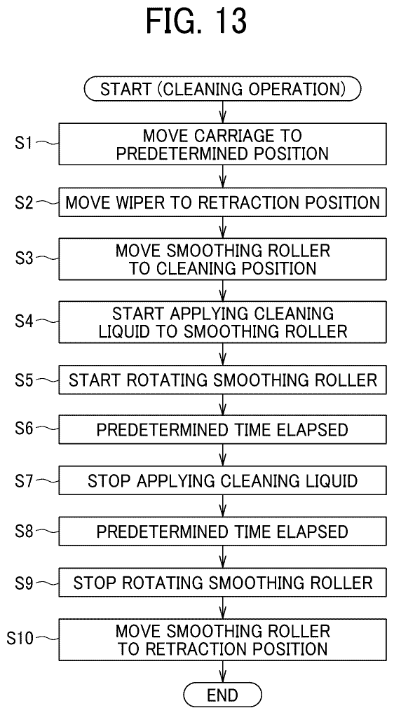

A description will be given below of an operation to be performed by the pretreatment maintenance unit 5 (cleaning device 9) when the pretreatment maintenance unit 5 cleans the smoothing roller 34, with reference to the flowchart of FIG. 13.

At the beginning of the cleaning operation, in step S1, the carriage 31 on which the smoothing roller 34 is mounted starts to move along the guide rail 33 in order to move the smoothing roller 34 to a predetermined position for cleaning. When the carriage 31 has moved to the predetermined position, as illustrated in FIG. 11, the smoothing roller 34 is located at the roller retraction position at which the smoothing roller 34 is retracted from the cleaning liquid nozzle 74a of the cleaning liquid applicator 74. To clean the smoothing roller 34, the smoothing roller 34 moves downward to the roller cleaning position facing the cleaning liquid nozzle 74a. In this case, if the wiper 73 is located at the wiper cleaning position facing the cleaning liquid nozzle 74a (see FIG. 11), in step S2, the wiper 73 moves downward to the wiper retraction position that does not face the cleaning liquid nozzle 74a, as illustrated in FIG. 12. Then, as illustrated in FIG. 12, in step S3, the smoothing roller 34 moves downward to the roller cleaning position.

In step S4, the cleaning liquid applicator 74 sprays the cleaning liquid 216 toward the smoothing roller 34 through the cleaning liquid nozzle 74a to start applying the cleaning liquid 216 to the smoothing roller 34.

At this time, in step S5, the smoothing roller 34 rotates while the cleaning liquid 216 is applied to the smoothing roller 34. This operation can effectively wash out foreign matter adhering to the circumferential surface of the smoothing roller 34 because the cleaning liquid 216 is applied to the entire surface of the smoothing roller 34 in a rotation direction. As an optional control, the smoothing roller 34 may not rotate while the cleaning liquid 216 is applied thereto.

The cleaning liquid 216 is applied to the smoothing roller 34 for a predetermined time. In step S6, the predetermined time has elapsed. After that, in step S7, the cleaning liquid applicator 74 stops applying the cleaning liquid 216. In this case, the smoothing roller 34 may stop rotating at the same time as the application of the cleaning liquid 216 stops. In FIG. 13, however, in step S8, the smoothing roller 34 continues rotating for a predetermined time even after the application of the cleaning liquid 216 has stopped. Then, after the predetermined time has elapsed, in step S9, the smoothing roller 34 stops rotating. As described above, the smoothing roller 34 continues rotating for the predetermined time even after the application of the cleaning liquid 216 has stopped. This operation can remove excess cleaning liquid 216 adhering to the smoothing roller 34 therefrom. Consequently, the excess cleaning liquid 216 on the smoothing roller 34 can be prevented from adhering to the sheet S during the smoothing step that will be performed next. The timing (i.e., the predetermined time) at which the smoothing roller 34 stops rotating may be determined by counting the rotational time of the smoothing roller 34 or by counting the number of rotations of the smoothing roller 34.

After both the spraying of the cleaning liquid 216 and the rotation of the smoothing roller 34 have stopped, in step S10, the smoothing roller 34 moves upward to the roller retraction position illustrated in FIG. 11. Thus, the series of cleaning operations is completed.

As described above, the controller 500 causes the cleaning liquid applicator 74 to stop applying the cleaning liquid 216 to the smoothing roller 34, and causes the smoothing roller 34 to continuously rotate for a predetermined time and stops rotating after stopping an application of the cleaning liquid 216 to the smoothing roller 34.

As described above, the cleaning device 9 mounted on the pretreatment maintenance unit 5 is used to clean the smoothing roller 34. This configuration can remove foreign matter adhering to the circumferential surface of the smoothing roller 34 without involving a user's or other person's manual cleaning operation. Consequently, a work burden on the user or other person can be reduced, and the circumferential surface of the smoothing roller 34 can be kept clean. As a result, image quality can be prevented from being lowered due to adhesion of foreign matter to the sheet S from the smoothing roller 34.

As described above, the cleaning device 9 for cleaning the pretreatment liquid discharge heads 32 is used to clean the smoothing roller 34. This configuration can provide a compact, low-cost apparatus. In other words, an existing cleaning device 9 for cleaning the pretreatment liquid discharge head 32 is used as a shared cleaning device for cleaning both the pretreatment liquid discharge head 32 and the smoothing roller 34. This configuration does not need to additionally install a cleaning device dedicated to cleaning the smoothing roller 34. Accordingly, enlargement of the cleaning device and a cost increase can be avoided.

Another example will be described below. Differences from the foregoing example will be described below, and the same descriptions may be omitted as appropriate.

### Another Example

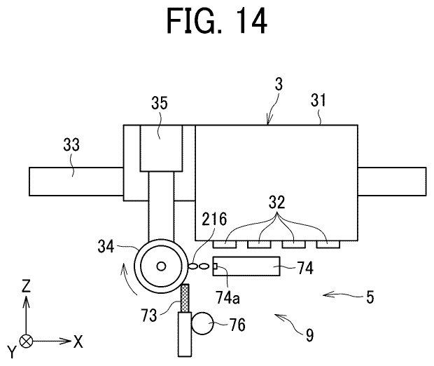

FIG. 14 is a diagram illustrating a configuration of the pretreatment maintenance unit 5 and a cleaning operation. In this example, as illustrated in FIG. 14, when the cleaning liquid applicator 74 applies the cleaning liquid 216 to the smoothing roller 34, the wiper 73 comes into contact with the smoothing roller 34. The other configurations are basically the same as in the foregoing example.

As described above, when the cleaning liquid applicator 74 applies the cleaning liquid 216 to the smoothing roller 34, the wiper 73 comes into contact with the smoothing roller 34. In this state, the smoothing roller 34 is rotating while the cleaning liquid 216 is being applied thereto. This configuration can scrape off foreign matter adhering to the circumferential surface of the smoothing roller 34 with the wiper 73 and can wash out the foreign matter from the circumferential surface with the cleaning liquid 216. Consequently, the foreign matter adhering to the circumferential surface of the smoothing roller 34 can be more effectively removed therefrom.

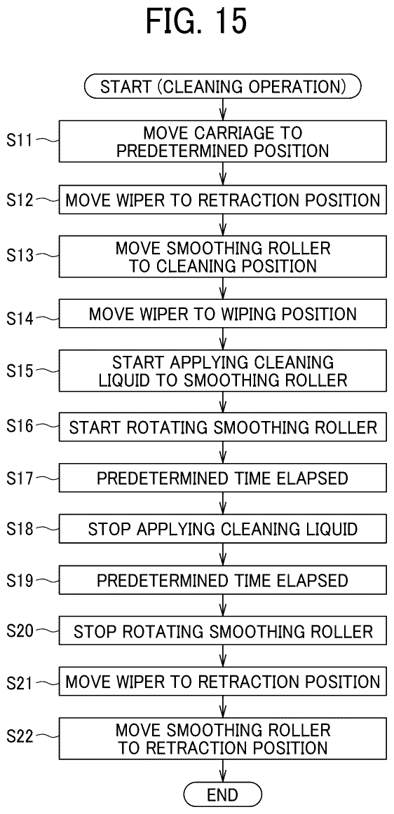

FIG. 15 is a flowchart of the cleaning operation by the pretreatment maintenance unit 5. At the beginning of the cleaning operation, similar to the foregoing example, in step S11, the carriage 31 moves to move the smoothing roller 34 to the predetermined position for cleaning. Then, in step S12, the wiper 73 moves to the wiper retraction position that does not face the cleaning liquid nozzle 74a. In step S13, the smoothing roller 34 moves downward to the roller cleaning position that faces the cleaning liquid nozzle 74a.

Following the above, in step S14, the wiper 73 moves upward to a roller wiping position at which the wiper 73 is in contact with the surface of the smoothing roller 34, as illustrated in FIG. 14.

Following the above, in step S15, the cleaning liquid applicator 74 starts applying the cleaning liquid 216 to the smoothing roller 34. Simultaneously, in step S16, the smoothing roller 34 starts rotating. As a result, the smoothing roller 34 rotates while the cleaning liquid 216 is applied thereto, with the wiper 73 kept in contact with the smoothing roller 34. Accordingly, the circumferential surface of the smoothing roller 34 is wiped by the wiper 73 to effectively remove foreign matter adhering to the circumferential surface of the smoothing roller 34 therefrom.

In step S17, a predetermined time has elapsed. After that, in step S18, the cleaning liquid applicator 74 stops applying the cleaning liquid 216. In this example, similarly to the foregoing example, in step S20, the smoothing roller 34 stops rotating when the predetermined time has elapsed in step S19 after the stop of the application of the cleaning liquid 216. Accordingly, the excess cleaning liquid 216 adhering to the smoothing roller 34 can be removed therefrom. Furthermore, the smoothing roller 34 continues rotating for the predetermined time with the wiper 73 kept in contact with the surface of the smoothing roller 34, after the stop of the application of the cleaning liquid 216. Accordingly, the wiper 73 can effectively remove the excess cleaning liquid 216 adhering to the smoothing roller 34 therefrom. Consequently, the excess cleaning liquid 216 on the smoothing roller 34 can be reliably prevented from adhering to the sheet S.

Following the above, in step S21, the wiper 73 moves to the wiper retraction position at which the wiper 73 is not in contact with the smoothing roller 34. Then, in step S22, the smoothing roller 34 moves upward to the roller retraction position that does not face the cleaning liquid nozzle 74a. Through such steps, this cleaning operation is completed.

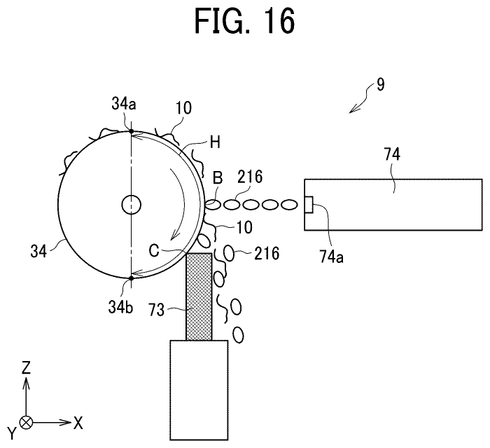

FIG. 16 is a diagram illustrating a relationship between a cleaning liquid application position B at which a cleaning liquid is applied to the smoothing roller 34 and a contact position C at which the wiper 73 is in contact with the smoothing roller 34.

As illustrated in FIG. 16, preferably, the cleaning liquid application position B of the smoothing roller 34 to which the cleaning liquid applicator 74 applies the cleaning liquid 216 is higher than, or above in the direction of gravity, the contact position C of the smoothing roller 34 with which the wiper 73 is in contact. In other words, the wiper 73 contacts the smoothing roller 34 at a first position (i.e., the contact position C), and the cleaning liquid applicator 74 applies the cleaning liquid 216 to the smoothing roller 34 at a second position (i.e., the cleaning liquid liquid application position B) higher than the first position.

As described above, the cleaning liquid application position B is higher than the contact position C of the wiper 73. Thus, after the cleaning liquid 216 is applied to the smoothing roller 34, the cleaning liquid 216 flows downward along the circumferential surface of the smoothing roller 34 and then reaches the contact position C of the wiper 73. In this way, foreign matter 10 that has been removed by the wiper 73 can be washed out by the cleaning liquid 216. Consequently, the foreign matter 10 on the smoothing roller 34 can be more effectively removed therefrom.

As illustrated in FIG. 16, the cleaning liquid application position B is preferably upstream from the contact position C of the wiper 73 in the rotation direction of the smoothing roller 34. More specifically, as illustrated in FIG. 16, the cleaning liquid application position B is preferably upstream from or above the contact position C of the wiper 73 in the rotation direction of the smoothing roller 34 within a range H from an uppermost position 34a of the surface of the smoothing roller 34 to a lowermost position 34b of the surface of the smoothing roller on the downstream side in the rotation direction (half of the circumferential surface of the smoothing roller 34 on the right side in FIG. 16).

As described above, the cleaning liquid application position B is upstream from the contact position C of the wiper 73 in the rotation direction of the smoothing roller 34. This arrangement facilitates the flow of the cleaning liquid 216 applied to the smoothing roller 34 to the contact position C of the wiper 73, which is downstream from the cleaning liquid application position B in the rotation direction, along with the rotation of the smoothing roller 34. Consequently, the foreign matter that has been removed by the wiper 73 can be reliably washed out by the cleaning liquid 216.

### Yet Another Example

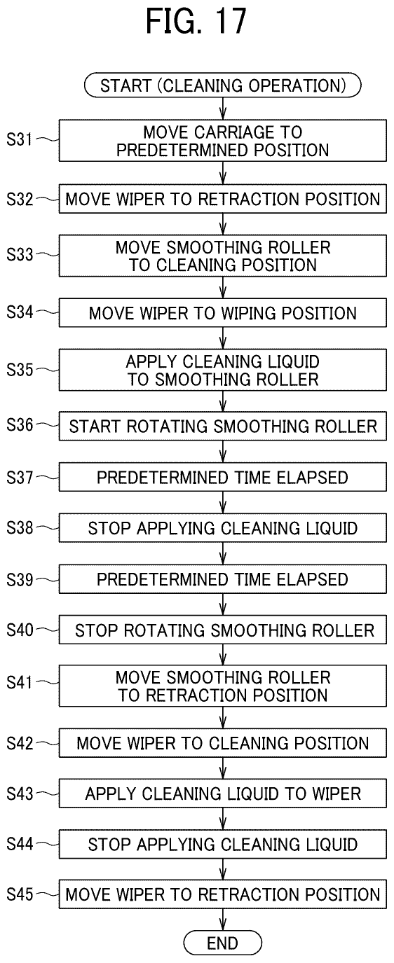

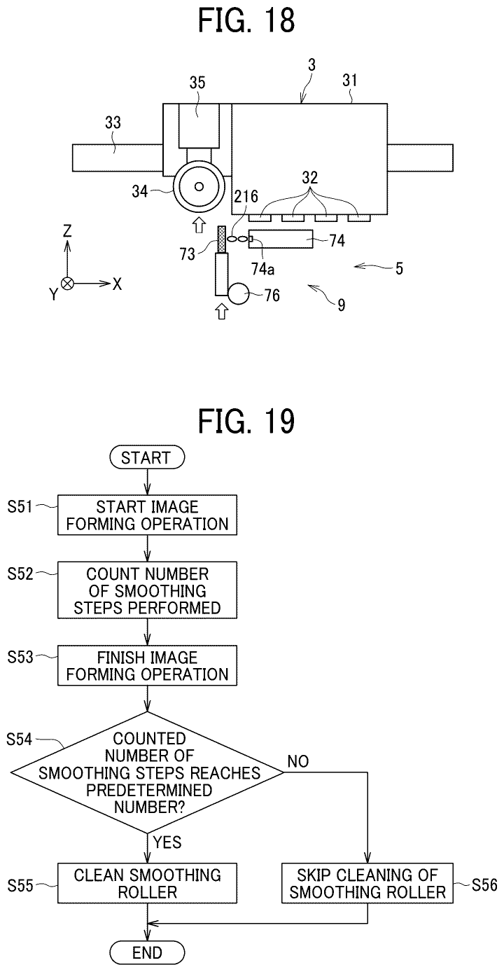

FIG. 17 is a flowchart of a cleaning operation by the pretreatment maintenance unit 5. FIG. 18 is a diagram illustrating a configuration of the pretreatment maintenance unit 5 and the cleaning operation.

In this example, steps S31 to S40 in FIG. 17 are the same as, respectively, steps S11 to S20 in FIG. 15. Accordingly, in this example, the cleaning liquid applicator 74 applies the cleaning liquid 216 to the smoothing roller 34 while the smoothing roller 34 is rotating and the wiper 73 is kept in contact with the smoothing roller 34 (see FIG. 14), similarly to the foregoing example. Thus, the smoothing roller 34 can be effectively cleaned.

When the smoothing roller 34 stops rotating in step S40, in step S41, the smoothing roller 34 moves upward to the retraction position that does not face the cleaning liquid nozzle 74a as illustrated in FIG. 18. In step S42, the wiper 73 moves upward to the wiper cleaning position that faces the cleaning liquid nozzle 74a.

After the wiper 73 has moved to the wiper cleaning position, in step S43, the cleaning liquid applicator 74 sprays the cleaning liquid 216 toward the wiper 73 through the cleaning liquid nozzle 74a, so that the cleaning liquid 216 is applied to the wiper 73. In step S44, the cleaning liquid applicator 74 stops applying the cleaning liquid 216. In step S45, the wiper 73 moves to the wiper retraction position that does not face the cleaning liquid nozzle 74a. Thus, the cleaning operation ends.

As described above, the controller 500 causes the cleaning liquid applicator 74 to apply the cleaning liquid 216 to the smoothing roller 34 while the wiper 73 contacts the smoothing roller 34, and causes the cleaning liquid applicator 74 to apply the cleaning liquid 261 to the wiper 73 after an application of the cleaning liquid 216 to the smoothing roller 34.

As described above, the wiper 73 is cleaned after the smoothing roller 34 has been cleaned, so that foreign matter adhering to the wiper 73 can be removed therefrom. Consequently, foreign matter can be prevented from adhering to nozzle faces 32n from the wiper 73, and thus the nozzle faces 32n can be satisfactorily cleaned.

### Cleaning Timing of Smoothing Roller

A timing of cleaning the smoothing roller 34 will be described below. The timing of cleaning the smoothing roller 34 may be different from a timing of cleaning the nozzle faces 32n of the pretreatment liquid discharge heads 32. For example, the number of the smoothing steps that have been performed may be counted. Then, when the number of the smoothing steps reaches a predetermined number, the cleaning device 9 may clean the smoothing roller 34.

FIG. 19 is a flowchart of a cleaning timing of cleaning the smoothing roller 34. As illustrated in FIG. 19, in step S51, the image forming operation is started. In step S52, the number of the smoothing steps is counted. The number of the smoothing steps that have been performed can be recognized, for example, by counting, by the main-scanning frequency counter 602 of FIG. 10, the number of times that the carriage 31 has moved in the main-scanning direction during the smoothing steps. Information regarding the number counted by the main-scanning frequency counter 602 is stored in a storage device, such as the ROM 502 of the controller 500.

In step S53, the image forming operation is finished. In step S54, when the counted number of the smoothing steps reaches the predetermined number (YES in step S54), in step S55, the cleaning device 9 performs the cleaning operation on the smoothing roller 34. When the counted number of the smoothing steps does not reach the predetermined number (NO in step S54), in step S56, the process ends, skipping the cleaning operation on the smoothing roller 34 by the cleaning device 9.

By determining whether to clean the smoothing roller 34 based on the counted number of the smoothing steps, the cleaning operation can be performed at a desired timing. Accordingly, the cleaning operation is not unnecessarily performed, and thus, for example, unnecessary consumption of the cleaning liquid and wear of the components and parts can be reduced.

Instead of being based on the number of the smoothing steps that have been performed, whether to clean the smoothing roller 34 may be determined based on a time that has elapsed from the previous cleaning timing. The time that has elapsed from the previous cleaning timing may be measured by, for example, the elapsed time counter 601 in FIG. 10. The counted time information may be stored in a storage device, such as the ROM 502. In this case, the smoothing roller 34 can be cleaned at a desired timing, and thus, for example, unnecessary consumption of the cleaning liquid and wear of the components and parts can be reduced.

The cleaning operation performed by the cleaning device 9 may be modified depending on the counted number of the smoothing steps or the measured elapsed time. For example, at a certain cleaning timing, the cleaning operation may be performed by applying the cleaning liquid 216 to the smoothing roller 34 as illustrated in FIG. 12, whereas at another cleaning timing, the cleaning operation may be performed by both applying the cleaning liquid 216 and wiping the smoothing roller 34 by the wiper 73 as illustrated in FIG. 14. The cleaning operation that involves both the applying of the cleaning liquid and the wiping can clean the smoothing roller 34 more effectively than the cleaning operation that involves the applying of the cleaning liquid alone. However, performing this cleaning operation may cause excessive wearing of the wiper 73 and the smoothing roller 34 due to the contact (sliding) therebetween. Accordingly, the cleaning operation that involves both the applying of the cleaning liquid and the wiping is selectively performed at a desired timing, depending on the counted number of the smoothing steps or the measured elapsed time. As a result, the wiper 73 and the smoothing roller 34 can be prevented from being excessively worn by the contact therebetween.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure.

For example, a cleaning device that cleans a smoothing roller may be a cleaning device to clean a pretreatment liquid discharge head that discharges a pretreatment liquid or a cleaning device to clean a discharge head that discharges liquid other than the pretreatment liquid.

The roller to be cleaned by the cleaning device may be a smoothing roller or a roller that comes into contact with a surface of a sheet for a purpose other than smoothing.

The liquid discharge apparatus described above is the image forming apparatus that discharges ink onto a sheet to form an image thereon as described above, or the liquid discharge apparatus may be an apparatus that discharges liquid onto a sheet for a purpose other than image formation.

For example, the liquid discharge apparatus is an apparatus that discharges a liquid such as a solution, a suspension, or an emulsion that contains a solvent such as water and an organic solvent, a colorant such as dye and pigment, a functional material such as a polymerizable compound, a resin, and a surfactant, a biocompatible material such as deoxyribonucleic acid (DNA), amino acid, protein, and calcium, and an edible material such as a natural colorant. Such a liquid can be used for surface treatment liquid, a liquid for forming components of an electronic element or a light-emitting element, or forming a resist pattern of electronic circuit, or a material solution for three-dimensional fabrication, as well as inkjet ink.

The liquid discharge apparatus according to embodiments of the present disclosure may include an aftertreatment device in addition to a device relating to feeding, conveying, and ejecting of a sheet and a pretreatment device.

The above-described embodiments of the present disclosure include at least the following aspects.

### Aspect 1

According to Aspect 1, a cleaning device cleans both a liquid discharge head that discharges liquid onto a sheet and a roller that moves in contact with a surface of the sheet.

In other word, a liquid discharge apparatus includes a liquid discharge head, a roller, and a cleaner. The liquid discharge head has a nozzle face having a nozzle to discharge a liquid, in a discharge direction, to a medium conveyed in a conveyance direction orthogonal to the discharge direction; and moves in a scanning direction orthogonal to the discharge direction and the conveyance direction. The roller moves in the scanning direction; and rotates and contacts a surface of the medium. The cleaner cleans each of the nozzle face and the roller.

In addition, the liquid discharge apparatus further includes a carriage mounting the liquid discharge head and the roller to move the liquid discharge head and the roller together in the scanning direction.

### Aspect 2

According to Aspect 2, the cleaning device of Aspect 1 further includes: a wiper that wipes a nozzle face of the liquid discharge head; and a cleaning liquid applicator that applies a cleaning liquid to the wiper and the roller.

In other word, in the liquid discharge apparatus according to Aspect 1, the cleaner includes a wiper to wipe the nozzle face and the roller, and a cleaning liquid applicator to apply a cleaning liquid to each of the wiper and the roller.

### Aspect 3

According to Aspect 3, in the cleaning device of Aspect 2, the cleaning liquid applicator applies the cleaning liquid to the roller during rotation of the roller.

In other word, in the liquid discharge apparatus according to Aspect 2, the cleaning liquid applicator applies the cleaning liquid to the roller while the roller is rotating.

### Aspect 4

According to Aspect 4, in the cleaning device of Aspect 2 or 3, the wiper is movable between a nozzle face wiping position at which the nozzle face is wiped and a cleaning position at which the cleaning liquid is applied by the cleaning liquid applicator.

In other word, in the liquid discharge apparatus according to Aspect 2 or 3, the wiper is movable, in the discharge direction, between a first position where the cleaning liquid applicator applies the cleaning liquid to the wiper and a second position where the cleaning liquid applicator applies the cleaning liquid to the roller.

### Aspect 5

According to Aspect 5, in the cleaning device of any one of Aspects 2 to 4, during rotation of the roller, the wiper comes into contact with the roller and the cleaning liquid applicator applies the cleaning liquid to the roller.

In other word, in the liquid discharge apparatus according to any one of Aspects 2 to 4, while the roller is rotating, the wiper contacts the roller, and the cleaning liquid applicator applies the cleaning liquid to the roller.

### Aspect 6

According to Aspect 6, in the cleaning device of Aspect 5, a position at which the cleaning liquid applicator applies the cleaning liquid to the roller is higher than a position at which the wiper comes into contact with the roller.

In other word, in the liquid discharge apparatus according to Aspect 5, the wiper contacts the roller at a first position, and the cleaning liquid applicator applies the cleaning liquid to the roller at a second position higher than the first position.

### Aspect 7

According to Aspect 7, in the cleaning device of Aspect 5 or 6, a position at which the cleaning liquid applicator applies the cleaning liquid to the roller is upstream, in a rotation direction of the roller, of a position at which the wiper comes into contact with the roller.

In other word, in the liquid discharge apparatus according to Aspect 5 or 6, the wiper contacts the roller at a first position, and the cleaning liquid applicator applies the cleaning liquid to the roller at a second position upstream from the first position in a rotation direction of the roller.

### Aspect 8

According to Aspect 8, in the cleaning device of Aspect 3, after the cleaning liquid applicator stops applying the cleaning liquid to the roller, the roller maintains rotation for a predetermined period of time and then stops the rotation.

In other word, the liquid discharge apparatus according to Aspect 3, further includes circuitry. The circuitry causes the cleaning liquid applicator to stop applying the cleaning liquid to the roller; and causes the roller to continuously rotate for a predetermined time and stops rotating after stopping an application of the cleaning liquid to the roller.

### Aspect 9

According to Aspect 9, in the cleaning device of any one of Aspects 2 to 8, after the wiper has come into contact with the roller and the cleaning liquid applicator has applied the cleaning liquid to the roller, the cleaning liquid applicator applies the cleaning liquid to the wiper.

In other word, the liquid discharge apparatus according to any one of Aspects 2 to 8, further includes circuitry. The circuitry causes the cleaning liquid applicator to apply the cleaning liquid to the roller while the wiper contacts the roller; and causes the cleaning liquid applicator to apply the cleaning liquid to the wiper after an application of the cleaning liquid to the roller.

### Aspect 10

According to Aspect 10, in the cleaning device of any one of Aspects 1 to 9, the roller is movable in a direction intersecting the surface of the sheet.

In other word, in the liquid discharge apparatus according to any one of Aspects 1 to 9, the roller contacts the surface of the medium onto which the liquid discharge head discharges the liquid, and the roller is movable in a direction intersecting the surface of the medium.

Alternatively, the roller is movable in the discharge direction with respect to the surface of the medium.

### Aspect 11

According to Aspect 11, a liquid discharge apparatus includes: a liquid discharge head that discharges liquid onto a sheet; a roller that moves in contact with a surface of the sheet; and the cleaning device of any one of Aspects 1 to 10 that cleans both the liquid discharge head and the roller.

In other word, the liquid discharge apparatus according to any one of Aspects 1 to 10, further includes a conveyor to convey the medium in the conveyance direction.

As described above, according to one aspect of the present disclosure, the cleaning device can be provided that cleans each of the liquid discharge head and the roller, and thus the liquid discharge apparatus including the cleaning device can be downsized.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

1. A liquid discharge apparatus comprising:
a liquid discharge head:
having a nozzle face having a nozzle to discharge a liquid, in a discharge direction, to a medium conveyed in a conveyance direction orthogonal to the discharge direction; and
to move in a scanning direction orthogonal to the discharge direction and the conveyance direction;
a roller to:
move in the scanning direction; and
rotate and contact a surface of the medium; and
a cleaner to clean each of:
the nozzle face; and
the roller.

2. The liquid discharge apparatus according to claim 1, further comprising:
a carriage mounting the liquid discharge head and the roller to move the liquid discharge head and the roller together in the scanning direction.

3. The liquid discharge apparatus according to claim 1,
wherein the cleaner includes:
a wiper to wipe:
the nozzle face; and
the roller; and
a cleaning liquid applicator to apply a cleaning liquid to each of:
the wiper; and
the roller.

4. The liquid discharge apparatus according to claim 3,
wherein the cleaning liquid applicator applies the cleaning liquid to the roller while the roller is rotating.

5. The liquid discharge apparatus according to claim 3,
wherein the wiper is movable, in the discharge direction, between:
a first position where the cleaning liquid applicator applies the cleaning liquid to the wiper; and
a second position where the cleaning liquid applicator applies the cleaning liquid to the roller.

6. The liquid discharge apparatus according to claim 3,
wherein, while the roller is rotating,
the wiper contacts the roller; and
the cleaning liquid applicator applies the cleaning liquid to the roller.

7. The liquid discharge apparatus according to claim 6,
wherein the wiper contacts the roller at a first position, and
the cleaning liquid applicator applies the cleaning liquid to the roller at a second position higher than the first position.

8. The liquid discharge apparatus according to claim 6,
wherein the wiper contacts the roller at a first position, and
the cleaning liquid applicator applies the cleaning liquid to the roller at a second position upstream from the first position in a rotation direction of the roller.

9. The liquid discharge apparatus according to claim 4, further comprising:
circuitry configured to:
cause the cleaning liquid applicator to stop applying the cleaning liquid to the roller; and
cause the roller to continuously rotate for a predetermined time and stops rotating after stopping an application of the cleaning liquid to the roller.

10. The liquid discharge apparatus according to claim 3, further comprising:
circuitry configured to:
cause the cleaning liquid applicator to apply the cleaning liquid to the roller while the wiper contacts the roller; and
cause the cleaning liquid applicator to apply the cleaning liquid to the wiper after an application of the cleaning liquid to the roller.

11. The liquid discharge apparatus according to claim 1,
wherein the roller contacts the surface of the medium onto which the liquid discharge head discharges the liquid, and
the roller is movable in a direction intersecting the surface of the medium.

12. The liquid discharge apparatus according to claim 1,
wherein the roller is movable in the discharge direction with respect to the surface of the medium.

13. The liquid discharge apparatus according to claim 1, further comprising a conveyor to convey the medium in the conveyance direction.
